(19) United States
(12) Patent Application Publication
(10) Pub. No.: US 2023/0110903 A1
(43) Pub. Date: Apr. 13, 2023

(54) INSULATION MEDIUM FOR AN ELECTRIC ENERGY TRANSFER DEVICE

(71) Applicant: Siemens Energy Global GmbH & Co. KG, München (DE)

(72) Inventors: Alexander Nijhuis, Spardorf (DE); Bernhard Lutz, Berlin (DE); Karsten Pohlink, Berlin (DE)

(21) Appl. No.: 17/909,488

(22) PCT Filed: Feb. 8, 2021
(86) PCT No.: PCT/EP2021/052914

§ 371 Date: Sep. 6, 2022

(30) Foreign Application Priority Data
Mar. 3, 2020 (DE) 10 2020 202 688.2

(51) Int. Cl. H02B 13/00; H01B 3/56

(52) U.S. Cl. CPC H02B 13/00; H01B 3/56

(57) ABSTRACT

An insulation medium for an electric energy transfer device. The insulation medium is a fluid at room temperature and at atmospheric pressure and the insulation medium includes at least the following components: >50 vol. % to <99 vol. % synthetic air, and >1 vol. % to <50 vol. % of an organic fluorine compound. Oxygen may be present at no more than 0.5 vol. %, or no more than 0.1 vol. %, or less.

The invention relates to an insulation medium for electrical energy transfer device, for instance for a high-voltage switch for a fluid-insulated tubular conductor, wherein the insulation medium is a fluid at room temperature and atmospheric pressure. The invention further relates to an electrical energy transfer device including such an insulation medium.

Electrical energy transfer devices, for instance gas-insulated tubular conductors or high-voltage switches or circuit breakers, are widely known in the field. They serve to conduct or to isolate high currents. In the case of high-voltage switches, it is usual to provide contact elements that can be brought into contact in order to enable an electrical connection, and that can be separated in order to be able to divide an electrical connection or isolate an electrical current. Tubular conductors usually comprise a conductor present in an insulating atmosphere.

In the case of separation of the contact elements, or even when the contact elements are brought together, there can be an arc. Arcs can put stress on the material of the contact elements and hence cause damage thereto.

In order to prevent this, it is known that the contact elements may be disposed within an insulation medium. This may, for example, be in gaseous form and may fill an insulation space in which the contact elements are disposed. Also known for prevention of arcs are vacuum circuit breakers.

DE 10 2017 220 570 A1 relates to an insulation medium for electrical energy transfer device, wherein the insulation medium is a fluid at room temperature and atmospheric pressure, and wherein the insulation medium includes at least the following constituents:
synthetic air in a proportion of 50% by volume to ≤99% by volume; and
an organic fluorine compound in a content of ≥1% by volume to ≤50% by volume.

Such solutions known from the prior art may offer further potential for improvement, especially with regard to possible long-term stability and long-term functionality of the contact elements and of the insulation medium itself.

It is an object of the present invention to at least partly overcome the disadvantages known from the prior art. It is a particular object of the present invention to provide a solution by which the long-term stability or long-term functionality and insulation quality of electrical energy transfer devices can be improved.

The object is achieved in accordance with the invention by an insulation medium for electrical energy transfer device having the features of claim 1. The object is also achieved in accordance with the invention by use of an insulation medium as electrically insulating atmosphere in a fluid-insulated electrical energy transfer device as claimed in claim 6. The object is also achieved in accordance with the invention by a fluid-insulated electrical energy transfer device having the features of claim 7. Preferred configurations of the invention are described in the dependent claims, in the description or the figures, and further features described or shown in the dependent claims or in the description or in the figures, individually or in any combination, may constitute part of the subject matter of the invention unless the opposite is clear from the context.

An insulation medium for an electrical energy transfer device is proposed, wherein the insulation medium is a fluid at room temperature and atmospheric pressure, and wherein the insulation medium has at least the following constituents:
nitrogen in a content of ≥75% by volume to ≤99% by volume; and
at least one organic fluorine compound in a content of ≥1% by volume to ≤15% by volume, where
oxygen is present in the insulation medium in a content of <0.5% by volume.

An above-described insulation medium permits reliable production or extinguishment of an arc in a high-voltage switch, and at the same time permits long-term stability or long-term functionality of operation of the high-voltage switch, and is also particularly advantageously suitable as insulating atmosphere in a fluid-insulated tubular conductor.

The insulation medium described here especially serves for use in an electrical energy transfer device. Examples that may be used as such a device include a high-voltage switch or else a fluid-insulated tubular conductor. A high-voltage switch in the context of the present invention may especially be understood to mean a switch device having an electrical conductor that can be opened or closed by corresponding contact elements and hence can permit or interrupt a flow of current. The high-voltage switch here may be suitable for carrying high currents or for the applying of a high voltage, where arcs can occur on separation or on opening of the contacts.

Illustrative currents that may be interrupted by a circuit breaker of a high-voltage switch may be within a range of up to 80 000 A. In addition, voltages across the switch device may be within a range of up to 800 000 V.

In addition, a fluid-insulated tubular conductor may especially be understood to mean a conductor for which customary operating voltages may be roughly up to 500 kV with rated currents per conductor of up to about 5 kA. The conductor here may be present in an outer tube, in which case an insulating atmosphere is present within the outer tube and surrounding the conductor, and there may be support insulators for mechanical support of the conductor.

In particular, the insulation medium may thus serve to insulate a volume that occurs within the electrical energy transfer device, especially the high-voltage switch or else disconnector or grounding switch, and to extinguish any arc that occurs, especially on separation, but also on closure, of contact elements, or to be able to ensure sufficient insulation in the tubular conductor.

In order to achieve this, what is envisaged with regard to the insulation medium is that it is a fluid, for example in gaseous form, at room temperature and atmospheric pressure, for instance within a range from atmospheric pressure to 10 bar (absolute). Room temperature is also understood in the context of the present invention to mean a temperature of 22° C., whereas atmospheric pressure is understood to mean a pressure of 1 bar, and stated pressures should fundamentally be considered to be absolute values. It may preferably be the case that the insulation medium is a fluid, for example in gaseous form, even under the operating conditions, i.e., for instance, at an elevated pressure and/or an elevated or reduced temperature, as described hereinafter.

The provision of a fluid insulation medium can make it possible, in a particularly simple manner, for the insulation medium to be introduced into and remain in an insulation space of the high-voltage switch for tubular conductor. In this way, the insulation medium may completely surround contact elements between which an arc can form in the case of separation or closure, or else a conductor in a tubular conductor. It is thus possible in principle to counteract the formation of an arc or to effectively assist extinguishment of the arc, or to bring about effective insulation of the conductor.

In principle, the provision of a gaseous insulation medium can enable ease of handling, for instance in the case of introduction into the insulation space, in the case of holding within the insulation space and, if necessary, in the case of exchange.

Finally, it is especially possible in the case of a gaseous insulation medium, through the formation of a suitable positive pressure in the insulation space, to adjust the amount of insulation medium present in the insulation space in a simple manner, and hence tailor the insulation capacity to the desired field of use.

Furthermore, in the case of the insulation medium described here, it is envisaged that the insulation medium has at least the following constituents:
nitrogen in a content of ≥75% by volume to ≤99% by volume; and
at least one organic fluorine compound in a content of ≥1% by volume to ≤15% by volume, where
oxygen is present in the insulation medium in a content of <0.5% by volume.

For example, the insulation medium may consist of nitrogen and the at least one organic fluorine compound in the aforementioned proportions, where any contaminants or impurities in the substances or fundamentally different substances should be noted and may be present, for instance, in a content of <0.1% by volume, for example in a content of <0.01% by volume.

What is especially characteristic about this insulation medium is thus its composition, which may especially consist essentially of nitrogen and the organic fluorine compound. Especially compared to solutions from the prior art, there is thus only very limited use, if any, of synthetic air or carbon dioxide in addition to the organic fluorine compound, but rather use of nitrogen of maximum purity. In this regard, it may be particularly preferable when oxygen and water are present collectively in the insulation medium in a content of 0.1% by volume, for example 0.01% by volume, for example of 1 ppm by volume, for instance of 0.5 ppm by volume, or else the insulation medium is entirely free of oxygen and water.

In principle, it may be the case for particularly effective advantages as described below for the insulation medium to include:
nitrogen in a content of ≥94% by volume to ≤97% by volume, for example of 95% by volume; and
at least one organic fluorine compound in a content of ≥3% by volume to ≤7% by volume, for example of 5% by volume, where
   oxygen and any other components may be present in the insulation medium in a content of ≤0.1% by volume, for example ≤0.01% by volume.

The configuration of the insulation medium as described here may have distinct advantages over solutions known from the prior art.

Particularly compared to solutions including synthetic air in the insulation medium, it is possible in accordance with the present invention to enable improved long-term stability or improved long-term functionality. This is because it has been found that it is especially possible to distinctly reduce the risk of corrosion mechanisms that may have a limiting effect in relation to a lifetime of switchgear compared to oxygen-containing and especially water-containing gas mixtures with fluoronitrile components in particular. Moreover, in cases of switching with high energy input (e.g. fault arcs, short circuit making capacity), there is a distinct reduction in accordance with the invention in the risk of combustibility, especially in the case of fluoronitrile levels of not less than 5%.

With regard to the aforementioned corrosion mechanisms that can be prevented or at least significantly reduced in accordance with the invention, the following should be mentioned:

In the case of prior art insulation media comprising a fluoronitrile and an oxidizing carrier gas, for instance oxygen, and optionally water, it has been found that compounds between the material of current-carrying components (generally copper or silver) and the oxidizing carrier gas (generally oxygen) form on the surfaces of the component. These are thus generally metal complexes, especially oxides, on the surface of the conductive components, which in turn enter into a reaction with the organic fluorine compound, especially fluoronitrile.

The effect of this is that the organic fluorine compound constituent, for instance fluoronitrile, from the insulation medium is broken down and the insulation medium is gradually depleted of insulating organic fluorine compound. Thus, the electrically insulating effect and the extinguishing effect of insulating medium are increasingly worsened by the aging process described.

It has been found that the use of the insulation gas described here prevents or so significantly reduces the formation of metal complexes or oxide formation at the surface that reaction with the fluorine compound, especially with nitrile groups of fluoronitrile, at the surface of the components is sustainably reduced and hence the aging properties of the insulation medium are distinctly improved.

Current-carrying components are understood to mean the components in the switchgear that serve to carry an electrical current; these are especially the contacts and the electrical feeds.

But even with respect to CO₂-containing gas mixtures, it is possible in accordance with the invention to enable improved properties. For example, it is possible to enable improved long-term leakproofing. This is because, in the case of the insulation medium described here, there is a distinct reduction in permeation mechanisms, for instance at elastic gasket materials, as described in greater detail hereinafter. Furthermore, insulation media according to the present invention do not have a significant tendency to form soot in disconnectors and grounding switches, which, in combination with vacuum circuit breakers, can likewise improve long-term functionality or long-term stability.

It is thus possible to enable, by virtue of an insulation medium described here, especially in combination with vacuum circuit breakers, effective extinguishment of an arc in disconnectors and grounding switches, and also long-term stability of operation even in the case of multiple switching actions of the high-voltage switch, or effective insulation of a conductor in an outer wall of a tubular conductor.

In addition, by means of insulation media including nitrogen and one or more organofluorine compounds in the above-described amounts, and by essentially dispensing with oxygen and especially water, it is possible to enable improved long-term leakproofing of switchgear or else in tubular conductors, as already indicated above. The reason for this may especially be that, based on standard polymers that are usually used as sealing materials, the insulation medium has a comparatively low permeation rate. More particularly, nitrogen has a particularly low permeation rate through standard polymers. Illustrative polymers as gasket materials include, for instance, EPDM (ethylene-propylene-diene rubber), NBR (nitrile-butadiene rubber), CR (chloroprene rubber), IIR (isobutene-isoprene rubber), SBR (styrene-butadiene rubber) or FKM (fluoropolymer rubber). In this way, it is possible to promote the reliable presence of the insulation medium over a prolonged period even at an elevated pressure without any need to use complex seal materials or sealing arrangements.

It thus also becomes effectively possible, even in the case of a simple construction of the insulation space, to operate it with a positive pressure. In this way, it is possible to configure the insulation resistance in a particularly effective manner with a simple construction.

The provision of at least one organofluorine compound, i.e. one or more organofluorine compounds, can also enable improvement in the dielectric strength of the insulation medium. In this way, the effectiveness of insulation can be particularly high, especially with respect to pure synthetic air or else with respect to pure nitrogen.

It may already be sufficient here when the organofluorine compound is present in the insulation medium within a range from ≥1% by volume to ≤15% by volume. These amounts of may relate to the fill pressure of the insulation space, which may be ≥4 bar to ≤10 bar, for instance ≥6 bar to ≤8 bar, where the above pressure values may be regarded as absolute values.

With regard to the nitrogen, it may be the case, for example, that it is obtained directly from the environment of the electrical energy transfer device or taken from bottles.

It is further preferable for the at least one organo-fluorine compound to be selected from the group consisting of fluoronitriles, for instance, perfluoronitriles, fluoroethers, for instance hydrofluoromonoethers, fluoroolefins, for instance hydrofluoroolefins, and fluoroketones, for instance perfluoroketones.

Preferred organofluorine compounds may be hydrofluoromonoethers having at least three carbon atoms, fluoroketones having a number of four to twelve carbon atoms, instance five or six carbon atoms.

Further preferably, the organic fluorine compound may be a perfluoroalkyl nitrile, for instance a compound selected from perfluoroacetonitrile, perfluoropropionitrile (C₂F₅CN), perfluorobutyronitrile (C₃F₇CN), perfluoroisobutyronitrile (CF₃)₂CFCN), perfluoro-2-methoxypropanenitrile (CF₃CF(OCF₃)CN), or mixtures thereof, as described, for instance, in WO2015/071303 A1. These compounds are generally referred to as fluoronitriles.

It has been found that, even in the use of such organochlorine compounds, dielectric strength or insulation quality can be particularly high. As a result, the effect of the quenching of an arc may be particularly effective, or effective electrical insulation of the contact element or of the conductor may be enabled even in the case of high currents.

It may also be the case that the insulation medium is essentially free of at least one, for example of all, of water, carbon dioxide and noble gases. For example, the insulation medium may be completely free of water, carbon dioxide and noble gases. What is meant here by “essentially free” in the context of the present invention is more particularly that the aforementioned substances may be present in the insulation medium in a proportion of 0.1% by volume, for example of 1 ppm by volume, for instance of ≤0.5 ppm by volume, or else it may be entirely free thereof.

In this configuration, the afore-mentioned corrosion mechanisms may be prevented particularly effectively, such that long-term stability can be improved especially in this configuration, particularly in the absence of water. Furthermore, the purity in this configuration is particularly high, and so the properties of the insulation medium are defined and predictable.

High-voltage switchgear based on the insulation medium of the invention, especially in combination with vacuum circuit breakers, also has improved lifetime particularly compared to SF₆ technology, for example on account of the breakdown of the gas by switching actions and through material burnoff.

In order to enable these advantages particularly effectively, it may be particularly preferable for the insulation medium to consist of nitrogen and at least one organofluorine compound. Thus, apart from nitrogen and at least one organofluorine compound, there may be essentially no further substances in the insulation medium. What is again meant here by “essentially free” in the context of the present invention is more particularly that, aside from the aforementioned substances, further substances may be present in the insulation medium only in a proportion of ≤0.1% by volume, for example of ≤1 ppm by volume, for instance of ≤0.5 ppm by volume, or may be absent entirely.

However, it is not ruled out in the context of the present invention that the insulation medium includes further constituents, for instance nitrogen oxides or carbon dioxide. However, this is preferably in a proportion of not more than 1% by volume, for example not more than 0.5% by volume.

With regard to further technical features and advantages of the insulation medium, reference is made to the remarks relating to the use and the electrical energy transfer device, and also to the figure and the description of the figure, and vice versa.

The present invention further relates to the use of an insulation medium as described above in detail as electrically insulating atmosphere in a fluid-insulated electrical energy transfer device, for instance in a high-voltage switch or as an electrically insulating atmosphere in a fluid-insulated tubular conductor.

Through the use of the insulation medium defined in detail above, it is especially possible to combine a high insulation quality with long-term stability of operation of the electrical energy transfer device. In addition, it is possible to enable particularly good insulation quality and long-term stability of the insulating atmosphere in the tubular conductor.

With regard to further technical features and advantages of the invention, reference is made to the observations relating to the insulation medium and the electrical energy transfer device, and also to the figure and the description of the figure, and vice versa.

The present invention further relates to a fluid-insulated electrical energy transfer device having a fluid-tightly sealed insulation space, wherein an insulation medium is disposed in the insulation space or in a reservoir connectable to the insulation space, wherein the insulation medium is configured as described in detail above.

An electrical energy transfer device may be understood here to mean any device in principle in which energy can be transferred, especially in the form of current.

It may be particularly preferable in the context of the invention for the electrical energy transfer device to include at least one of a high-voltage switch and a fluid-insulated tubular conductor.

A high-voltage switch and a fluid-insulated tubular conductor here are especially configured as described in detail above and hereinafter.

Correspondingly, it may be advantageous that, in a tubular conductor, which usually has a conductor disposed within an outer wall and surrounded by an insulating atmosphere, a high insulation quality of the conductor is enabled. Thus, the space in the tubular conductor that surrounds the conductor and is surrounded by an outer wall is the insulation space in which the insulation medium is present, preferably permanently, in a tubular conductor.

With regard to the high-voltage switch, it may especially be advantageous for improved service life to be achieved by the prevention of corrosion mechanisms.

In a manner known per se, the high-voltage switch comprises an insulation space also referred to as fluid accommodation space. A first switching unit is disposed therein, which may especially take the form of a grounding switch or of a disconnector or of a grounding switch and disconnector. Separation of contact elements of the first switching unit may give rise to an arc which is thus caused by the first switching unit and should be extinguished.

For this purpose, it is envisaged that an insulation medium is provided in the insulation space itself, i.e. preferably permanently and independently of switching actions that take place, or else in a reservoir that can be connected to the insulation space, for instance in the event of an impending switching action. The insulation medium serves to insulate the insulation space and may also serve to extinguish an arc.

By virtue of use of an insulation medium as described above, it is possible to enable a distinct improvement in long-term stability, for instance in that the permeation rate can be particularly low, and corrosion mechanisms based on the insulation gas can also be prevented.

It may more preferably be the case with regard to a high-voltage switch that, in addition to the first switch unit, a second switch unit and optionally a third switch unit are disposed in the insulation space, wherein the first switch unit and the third switch unit each have at least one of a disconnector and a grounding switch, and wherein the second switch unit has a circuit breaker, such as a vacuum switch in particular. Thus, in this configuration, a grounding switch, a disconnector and a circuit breaker, especially a vacuum switch, are provided, where the grounding switch and the disconnector may be separated from one another or may take the form of a single switching unit. The vacuum switch in particular may be advantageous.

The circuit breaker, especially a vacuum switch, can be triggered here independently of disconnectors and grounding switches, for instance if faults occur, for example short-circuits in the power grid, and it is necessary to interrupt high short-circuit currents.

Disconnectors and grounding switches are particularly safety-relevant switchgear and are triggered comparatively rarely, for instance when maintenance work has to be conducted or a switch between busbars takes place. Switching of a disconnector or grounding switch is usually preceded by switching of the circuit breaker.

In other words, in this configuration, there is a disconnector and a grounding switch in the insulation space, both of which are surrounded by the insulation medium. Additionally provided in the insulation space is a vacuum switch, where the contact elements of the vacuum switch are not in contact with the insulation medium, but are present in a vacuum atmosphere. It becomes clear from this that the main function of the insulation medium is not the prevention of the formation of soot or the extinguishment of an arc.

It may be the case here that the insulation space is divided into a multitude of regions, for example by fluid-tight, for instance gas-tight, or fluid-permeable, for instance gas-permeable, divisions, in which case all or only some of the individual regions of the insulation space, but especially the region of the insulation space surrounding the first insulation unit and optionally the region of the insulation space surrounding the third insulation unit, are filled with the insulation medium.

The circuit breaker here may especially be a vacuum circuit breaker and may serve for breaking of high currents, especially short-circuit currents, whereas the disconnector and the grounding switch may serve to interrupt small currents, especially commutation currents, charging currents and induced currents, where the insulation medium serves as light arc extinguishment medium for disconnectors and grounding switches.

The circuit breaker, for instance the vacuum switch, can interrupt currents within a range from 25 000 A to 80 000 A, and voltages across it may be within a range from 72 500 V to 800 000 V.

A disconnector may also interrupt currents within a range from 0.1 A to 8000 A, and voltages across it may be within a range from 10 V to 1000 V.

A grounding switch may additionally interrupt currents within a range from 0.4 A to 500 A, and voltages across it may be within a range from 500 V to 70 000 V.

The above-described values should not necessarily be considered to be limiting.

An increase in the lifetime of the switchgear may be achieved here in a particularly effective manner in that a vacuum circuit breaker is used, for which low-burnoff materials in particular may be used, for example tungsten-copper or copper-chromium alloys. In addition, on account of the vacuum, there are only a few molecules, if any, that would serve for burnoff of the contact elements and could also break down. In other words, owing to the “absence” of gas molecules, no gas aging can take place. This can further improve long-term stability.

Thus, more particularly, the use of the above-described insulation medium in combination with a vacuum switch as preferred circuit breaker may be an optimal solution for switchgear having a high lifetime, which is especially applicable to use in high-voltage technology.

With regard to vacuum switch, it may be advantageous that, in a switching space of the vacuum switch or of the second switching unit, there is a pressure within a range from 10⁻¹⁰ bar to 10⁻⁶ bar (absolute).

It may also be particularly preferable with regard to the insulation space that the insulation medium in the insulation space is present at a pressure within a range from not less than 4 bar (absolute) to not more than 10 bar (absolute).

With regard to further technical features and advantages of the electrical energy transfer device, reference is made to the remarks relating to the insulation medium and the use, and also to the figure and the description of the figure, and vice versa.

Further details, features and advantages of the subject matter of the invention are apparent from the dependent claims and from the description of the figure that follows and the corresponding example. The figure shows:

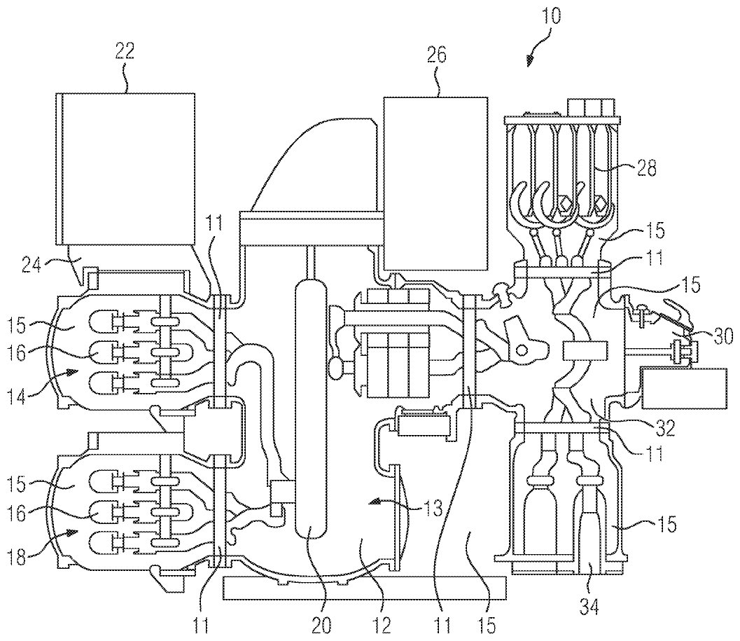

FIG. 1 a schematic of a configuration of a high-voltage switch as electrical energy transfer device according to the present invention.

FIG. 1 shows a schematic example of a configuration of electrical energy transfer device in the form of a high-voltage switch 10 according to the invention.

The high-voltage switch 10 comprises a gas-tightly sealed insulation space 12 with an insulation medium 13 disposed therein, as described in detail hereinafter.

It is also shown that a first arrangement 14 composed of first switching unit 16 is disposed in the insulation space 12. Also disposed in the insulation space 12 is a second arrangement 18 composed of first switching units 16. The first switching unit 16 is configured as a combined grounding switch and disconnector. The first arrangement 14 of the second arrangement 18 thus each bear switching units 16 having grounding switches and disconnectors.

Likewise disposed within the insulation space 12 is a second switching unit 20. The second switching unit 20 comprises a circuit breaker and is preferably configured as a vacuum switch. The vacuum switch has a switching space with a separable contact, with an illustrative pressure of not more than 10⁻⁶ bar in the switching space. This shows that the insulation space 12 is divided by gas-tightly or gas-permeably configured divisions 11 into a multitude of regions 15, with all regions 15 of the insulation space 12 in this configuration filled with the insulation medium 13.

As an alternative to this configuration, it could also be the case that the first switching unit 16 constitutes merely a grounding switch and, correspondingly, a third switching unit comprising the disconnector would be provided. The third switching units would then be part of the first arrangement 14 and of the second arrangement 18, or of further arrangements that are not shown.

Also shown are a control cabinet 22, by means of which the high-voltage switch 10 can be controlled and which sits on a console 24.

In order to operate the vacuum switch as second switching unit 20, also provided is a spring energy storage drive 26 with a circuit breaker control drive. Also shown are a voltage transducer 28 and a fast-action grounding switch 30. Finally, FIG. 1 also shows an output module 32 with further disconnectors and grounding switches, and a sealed cable end 34.

Coming back to the insulation space 12 and the insulation medium 13 disposed therein, it is preferably the case that this is that a positive pressure, where the positive pressure may, for example, be within a range from not less than 4 bar to not more than 10 bar. Thus, the entire insulation space 12 is gas-tight even in the case of a corresponding positive pressure.

The insulation medium 13 is also configured in that it has the following constituents:
nitrogen in a content of ≥75% by volume to ≤99% by volume; and
at least one organic fluorine compound in a content of ≥1% by volume to ≤15% by volume, where oxygen is present in the insulation medium in a content of <0.5% by volume, where
   the fluorine compound may include, for example, fluoro-nitriles, for instance, perfluoronitriles, fluoroethers, for instance hydrofluoromonoethers, fluoroolefins, for instance hydrofluoroolefins, and fluoroketones, for instance perfluoroketones.

In addition, oxygen and, for example, fundamentally different compounds are present in the insulation medium in a content of <0.5% by volume.

For example, the insulation medium 13 may consist of nitrogen and the at least one organic fluorine compound, such that the insulation medium 13 is essentially free of at least one of water, carbon dioxide and sulfur hexafluoride.

Further by way of example, it may be the case that the insulation medium 13 includes:
nitrogen in a content of ≥94% by volume to ≤97% by volume; and
at least one organic fluorine compound in a content of ≥3% by volume to ≤7% by volume.

The individual combinations of the constituents and of the features of the executions mentioned in each case are illustrative; the exchange and substitution of these teachings for other teachings present in this publication with the publications cited are likewise explicitly contemplated. It will be apparent to the person skilled in the art that variations, modifications and other executions that are described here may likewise occur without departing from the concept of the invention and the scope of the invention.

Correspondingly, the above description should be considered by way of example and not in a limiting manner. The word “comprise” used in the claims does not rule out other constituents or steps. The indefinite article “a” does not rule out the meaning of a plural. The mere fact that particular dimensions are recited in mutually different claims does not mean that a combination of these dimensions cannot be utilized advantageously. The scope of the invention is defined in the claims that follow and the corresponding equivalents.

1-10 (canceled)

11. An insulation medium for an electrical energy transfer device, the insulation medium comprising:
an insulation medium composition being a fluid at room temperature and at atmospheric pressure;
said insulation medium composition having the following constituents:
nitrogen at ≥75% by volume to ≤99% by volume; and
at least one organic fluorine compound at ≥1% by volume to ≤15% by volume;
oxygen in the insulation medium at a content of <0.5% by volume.

12. The insulation medium according to claim 11, wherein oxygen and water are collectively present in the insulation medium composition at ≤0.1% by volume.

13. The insulation medium according to claim 11, wherein the insulation medium composition comprises:
nitrogen from ≥94% by volume to ≤97% by volume; and
at least one organic fluorine compound from ≥3% by volume to ≤7% by volume.

14. The insulation medium according to claim 11, wherein said insulation medium composition consists of nitrogen and at least one organofluorine compound.

15. The insulation medium according to claim 11, wherein the at least one organofluorine compound is a fluoronitrile.

16. A method of insulating an electrical energy transfer device, the method comprising filling an insulation medium according to claim 11 into the electrical energy transfer device to form an electrically insulating atmosphere in the fluid-insulated electrical energy transfer device.

17. A fluid-insulated electrical energy transfer device, comprising:
a fluid-tightly sealed insulation space; and
an amount of insulation medium according to claim 11 disposed in said insulation space or in a reservoir to be connected to said insulation space.

18. The electrical energy transfer device according to claim 17 being one of a high-voltage switch or a fluid-insulated tubular conductor.

19. The electrical energy transfer device according to claim 17, comprising:
a high-voltage switch having said insulation space;
said high-voltage switch including a first switch unit and a second switch unit disposed in said insulation space of said high-voltage switch, wherein said first switch unit has at least one of a disconnector or a grounding switch, and wherein said second switch unit has a circuit breaker.

20. The electric energy transfer device according to claim 19, wherein said high-voltage switch further comprises a third switch unit disposed in said insulation space and said third switch unit has at least one of a disconnector or a grounding switch.

21. The electric energy transfer device according to claim 19, wherein said circuit breaker is a vacuum circuit breaker.
